(19) United States
(12) Patent Application Publication
(10) Pub. No.: US 2007/0187200 A1
(43) Pub. Date: Aug. 16, 2007

(54) Method for producing a mechanical part provided with a plastic moulded lining and mechanical part obtained with said method

(76) Inventor: Stephane Gravier, Lyon (FR)

Correspondence Address: CLARK & BRODY, 1090 VERMONT AVENUE, NW, SUITE 250, WASHINGTON, DC, 20005, US

(21) Appl. No.: 10/668,367

(22) Filed: Sep. 24, 2003

(30) Foreign Application Priority Data
Sep. 24, 2002 (FR) 02 11 759

(51) Int. Cl. F16D 55/18; B29C 45/14; F16F 9/36

(52) U.S. Cl. 188/322.17; 264/259

(57) ABSTRACT

The method for manufacturing a mechanical part comprising a body fitted with at least one lining in plastic material, is characterized in that it consists in particular of: making the body of the part so that it comprises at least one detachable member defining, at least in part, an impression for over-moulding the lining,
placing the body in a mould (25) as central core, closing the mould, injecting plastic material to mould the lining onto the body, opening the mould, removing from the mould the mechanical part comprising the body and its lining, detaching the detachable member from the body. Brake piston

The invention concerns the technical area of mechanics and more especially the area concerning the manufacture and use of mechanical parts which, for their operation, require plastic moulded linings intended to act as seal.

In the preferred but non-exclusive field of application of the invention i.e. the braking circuit of motor vehicles, inside a hydraulic command cylinder called a “master cylinder”, a piston is known to be used fitted on the outside with a lining in plastic material or elastomer such as rubber. This lining is most frequently force or extension mounted on the piston inside an outer peripheral groove.

While pistons so assembled, insofar as they have successfully passed quality control tests, generally give full satisfaction in respect of their functioning, this method of manufacture nevertheless has a certain number of disadvantages which, while not always unacceptable, nevertheless penalize performance of piston use and, to a lesser extent, performance of piston manufacture.

The placing of the elastomer lining in its receiving groove requires temporary deformation of the lining which may lead to local tearing or even complete rupture of the lining. Local tears may result either from poor handling or from assembly using faulty tooling, or they may occur when the yield point of the lining's elasticity is reached during assembly. Therefore, the various operations conducted are liable to make a lining faulty even though it had met required quality criteria just after manufacture.

The consequences of a complete tear occurring during the piston manufacturing process are none other than the discarding of the damaged lining and its replacement by an intact lining. This loss of lining also hinders the course of piston production.

Local tears, on the other hand, which are not always visible after assembly, may unexpectedly lead to ill-functioning of the hydraulic system which integrates the piston on which it is mounted. Said ill-functioning may have consequences on the safety of the vehicle equipped with this hydraulic circuit or, at the very least, be the cause of mechanical deteriorations resulting from clutch ill-functioning.

There is therefore an apparent need for a new method to manufacture the above pistons which can, inasmuch as possible, reduce the risks of latent defects in seal linings used to equip pistons.

In the same technical area of hydraulic command circuits fitted to motor vehicles, the need is also known to use fixed parts, more generally called bearings, to guide the piston of a master cylinder. Said bearings have an elastomer lining arranged inside an inner peripheral groove in relation to a central bore inside which the piston of the master cylinder follows a translatory movement. According to the current technique, the guide bearing is formed by the assembly of several parts, comprising at least one main part having a bore inside which the seal and guide lining is placed, and a secondary part intended to screw or clip onto it, for example inside the bore, to immobilize the lining in its final position.

Said method of assembly necessitates a complex bearing design in several parts and requires numerous handling operations to mount and assemble the said bearing. It is to be noted however that the handling operations made on the bearing and inner lining, between its manufacture and assembly, amount to as many risks of soiling and polluting the lining with foreign particles, which may affect suitable functioning of the system which integrates the bearing and lining assembly. Also, having regard to the number of parts of which it consists, said bearing has a relatively high production cost.

There is therefore also an apparent need for a new method to manufacture the above bearing which, inasmuch as possible, brings a reduction in the number of parts used and a reduction in the risks of latent defects in the lining fitted to the bearing.

It is to be noted that the same problem arises for all mechanical parts on which it is necessary to use a seal lining in plastic material or elastomer when the assembly of the lining is likely to cause its damage or may require additional parts for its immobilization in particular.

The invention therefore sets out to provide a solution to the different problems raised above by proposing a new method for manufacturing a mechanical part comprising a body fitted with at least one lining in plastic material.

According to the invention, this method is characterized in that it comprises at least the following steps:
making the body of the part so that it comprises at least one detachable member defining, at least in part, an impression for over-moulding the lining,
placing the body as central core in a mould,
closing the mould,
injecting plastic material to mould the lining onto the body
opening the mould
releasing from the mould the mechanical part comprising the body and its lining
detaching the detachable member from the body.

According to one characteristic of the invention, the method consists of making the body and detachable member such that the detachable member is joined to the body by at least one zone of lesser resistance and of detaching the detachable member by breaking this zone of lesser resistance.

According to another characteristic of the invention, the method consists of making the body of the part by adding the detachable member to the body. In preferred manner, the detachable member in this case is force fitted onto or into the body of the part.

According to another characteristic of the invention, the detachable member is made so that it has zones of lesser resistance or scored zones making it possible to break off the detachable member to facilitate its removal after moulding the lining.

According to a further characteristic of the invention, the impression, defined by the detachable member, is arranged to ensure the moulding or conformation of at least one functional surface of the lining and preferably, but not exclusively, of a sealing lip and/or sealing surface, whether dynamic or not, intended to cooperate with a mechanical part other than the one on which the lining is over-moulded.

It is to be noted that this characteristic may, in advantageous manner, be associated with the fabrication of the detachable member in scored form. In this way it is possible to obtain a functional surface, conformed by the detachable member, with no transverse or radial joint line. The functional surface so obtained has practically no roughness or irregularities and hence gives good performance.

The invention also concerns a mechanical part comprising a body intended to receive at least one seal lining in plastic material. According to the invention, this mechanical part is characterized in that the body comprises at least one detachable member defining, at least in part, an impression for over-moulding the lining in plastic material.

According to one characteristic of the invention, the detachable member is joined to the body by at least one scored zone of lesser resistance.

According to another characteristic of the invention, the detachable member is added onto or force fitted onto or into the body.

According to one characteristic of the invention, the detachable member has zones that are scored or are of lesser resistance intended to facilitate removal of the detachable member.

Various other characteristics of the invention will become apparent in the following description with reference to the appended drawings which, as non-restrictive examples, show forms of embodiment and use of the subject of the invention.

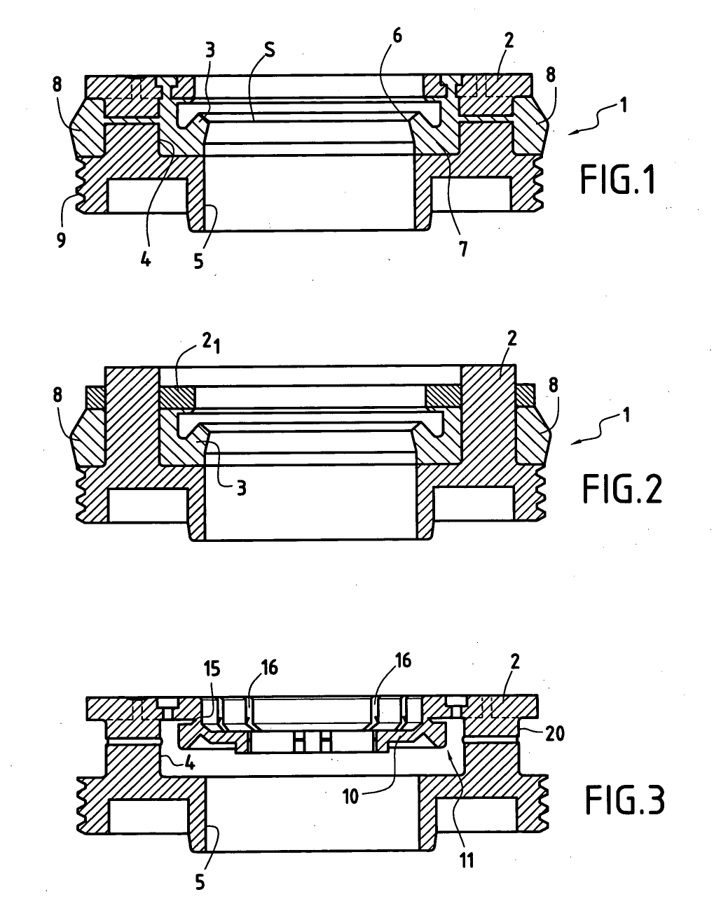

FIG. 1 is an axial section of a first example of embodiment of a mechanical part of the invention, called a guide bearing, having two over-moulded linings in plastic material.

FIG. 2 is a view of the guide bearing of the prior art.

FIG. 3 is an axial section showing the body of the mechanical part in FIG. 1, in accordance with the invention, with no over-moulded lining and fitted with a detachable member defining in part an impression for over-moulding a lining inside said part.

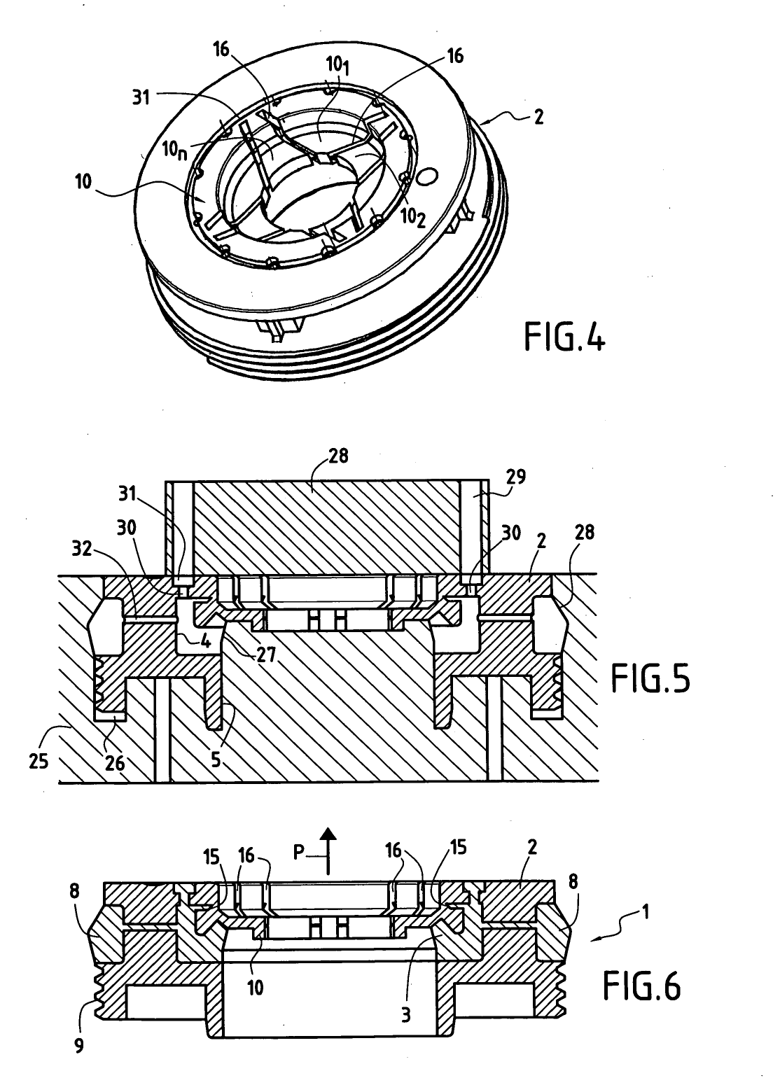

FIG. 4 is a perspective view of the part in FIG. 3.

FIGS. 5 and 6 are axial views showing the different phases of the manufacturing method for the part in FIG. 1.

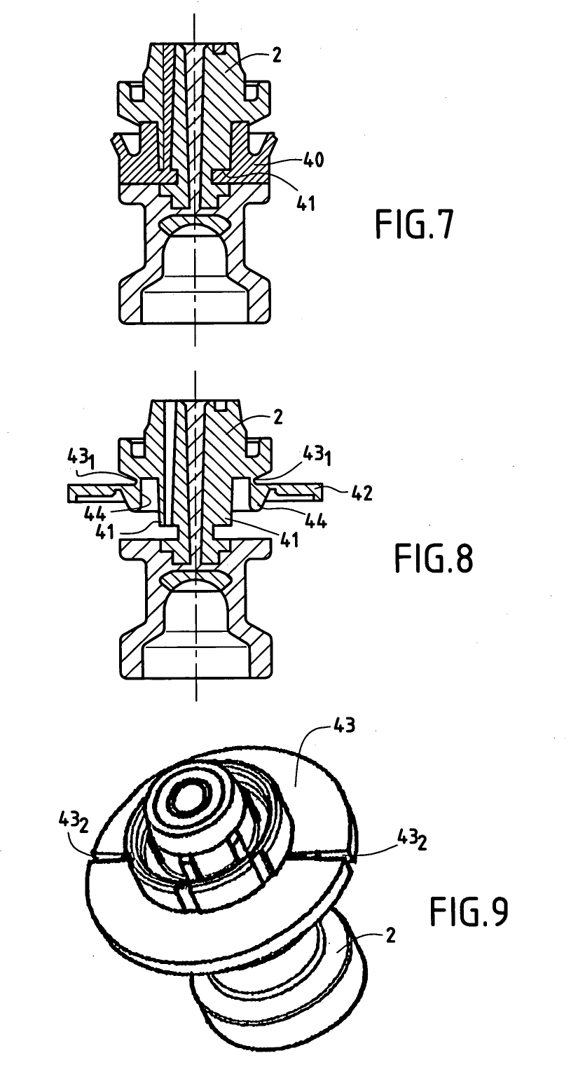

FIG. 7 is an axial section of a part having an outer lining according to another embodiment of the invention.

FIG. 8 is an axial section of the semi-finished or intermediate mechanical part used, according to the invention, to produce the part in FIG. 7.

Fig.9 is a perspective view of the part in FIG. 8.

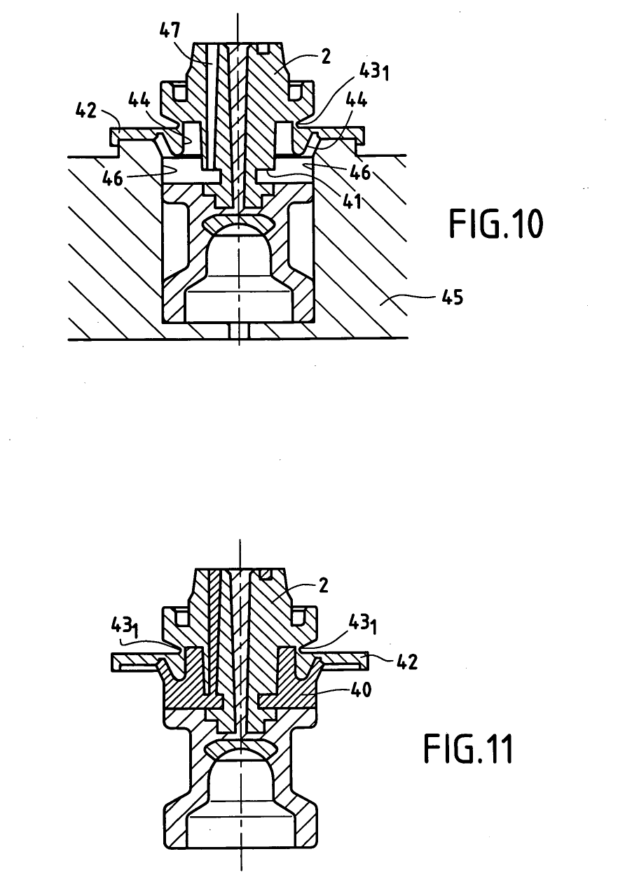

FIGS. 10 and 11 illustrate different steps in the method of manufacture of the invention for the mechanical part in FIG. 7.

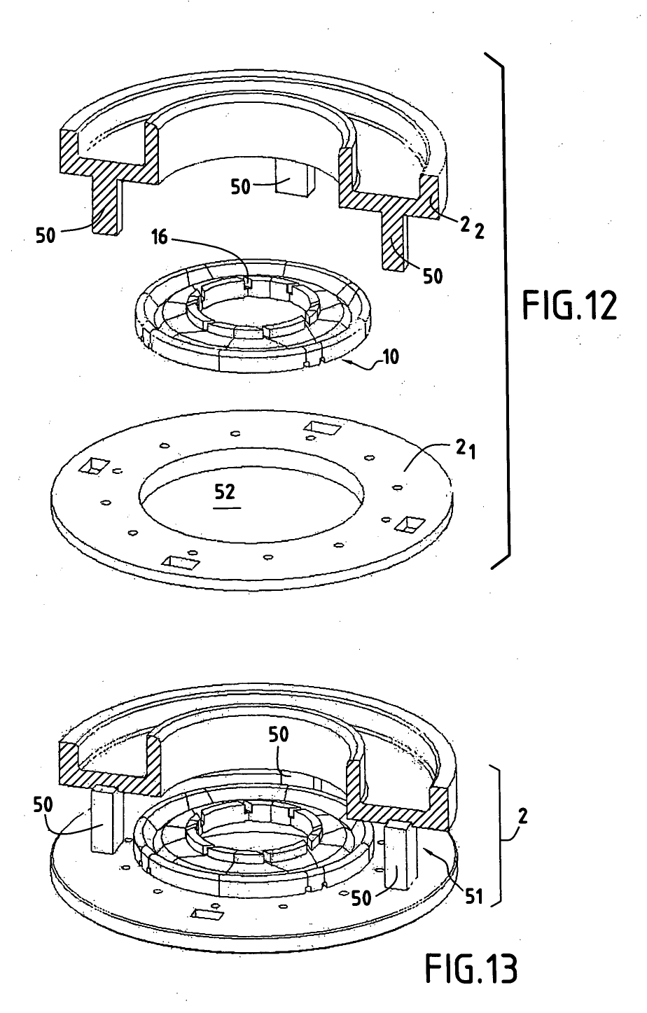

FIGS. 12 to 16 illustrate another form of embodiment of a part according to the invention for which the body is made in several parts and the detachable member is added onto the body.

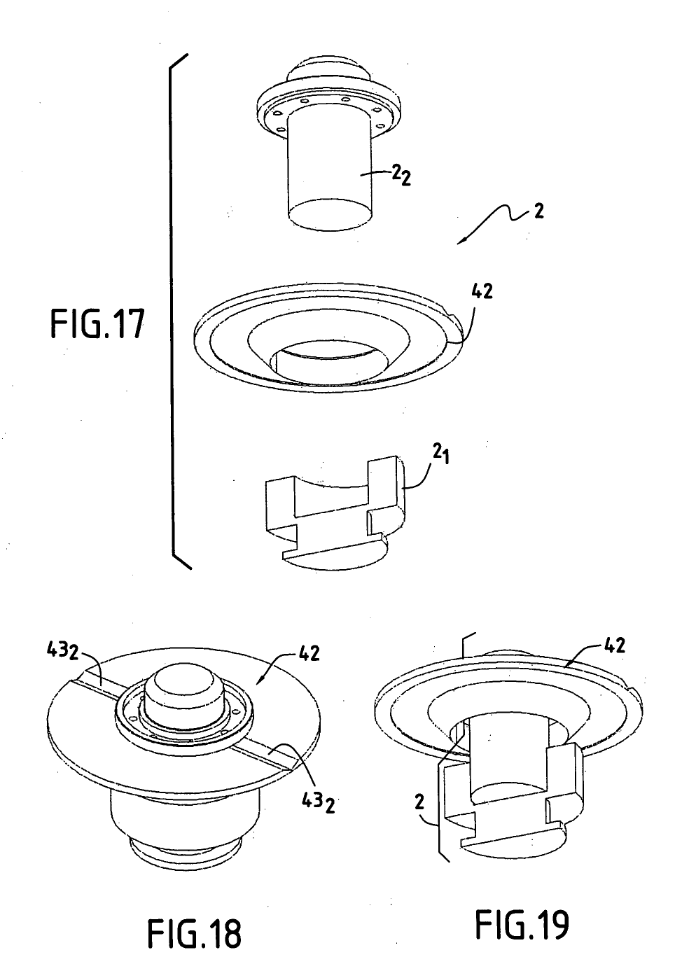

FIGS. 17 to 19 illustrate another form of embodiment of the part such as illustrated in FIGS. 7 to 11, according to which the detachable member is also added onto the body of the said part.

The invention sets out to provide a method for manufacturing a mechanical part such as illustrated in FIG. 1, and designated in its entirety by reference 1 which comprises a body 2 fitted with a lining 3 in plastic material defining at least one functional contact surface S with another mechanical part not shown which is mobile relative to first part 1.

According to the illustrated example, part 1 forms a guide bearing for a master cylinder piston, not shown, lining 3 is placed inside an annular groove 4 arranged in relation to an inner bore 5 of part 1 inside which the master cylinder piston moves. Inner lining 3 then has a lip 6 which defines the functional surface S which guides the master cylinder and provides a dynamic seal around it. Lining 3 also comprises an inner lip or heel 7 which ensures a static seal for body 2. Having regard to its function, guide bearing 1 also has an outer seal lining 8, intended to ensure a static seal in relation to the master cylinder, not shown, in which bearing 1 is intended to be adapted and fixed by means of a thread 9.

The main difficulty inherent in the manufacture of part 1, lies in the positioning of inner lining 3. The prior art, up until now and as shown in FIG. 2, recommended making body 2 in several parts, so as to be able firstly to place lining 3 in a bore and then to immobilize it by means of an additional part closing said bore to delimit a groove to house said lining 3. However, said method of manufacture of body 2 requires a high number of parts and operations to achieve the final part as illustrated in FIG. 2

In highly advantageous manner, the invention proposes doing away with these various steps of design and manufacture by over-moulding inner lining 3 directly inside body 2.

For this purpose, and in order to define in satisfactory manner the special shape of the dynamic seal lip 6 of lining 3, the invention recommends during an initial or preliminary step to produce body 2 of the part so that, as shown in FIG. 3, it comprises at least one detachable member 10 defining an impression 11 to over-mould lining 3. According to the illustrated example, detachable member 10 is arranged in relation to groove 4 intended to house lining 3.

Body 2 and detachable member 10 may be made in any manner and in any appropriate material. According to one preferred but non-exclusive embodiment, body 2 and detachable member 10 are made in moulded plastic material and form a single-piece assembly. Detachable member 10 is then joined to body 2 via a scored zone of lesser resistance 15 whose function is described below. Also, having regard to the arrangement of detachable member 10 inside body 2 in relation to groove 4, the member 10 is divided into sectors by zones of lesser resistance 16 such as shown in FIG. 4 in which detachable member 10 is shaded. The function of these lines of lesser resistance 16 extending from connection zone 15 to the center of detachable member 10 will be more clearly seen below.

According to the example shown, body 2 also has an outer groove 20 inside which lining 8 is over-moulded.

The fabrication of part 1 according to the invention is conducted as follows.

Firstly, body 2 is arranged as a central core in the main body 25 of a mould as shown in FIG. 5. For this purpose, this main body 25 has a housing 26 for body 2. Body 25 also comprises an impression 27 complementary to impression 11 defined by detachable member 10 to ensure conformation of inner lining 3. Body 25 also has an impression 28 to conform an outer lining 8.

Subsequently, an injection head 28 is placed above body 2 so as to position inlet channels 29 for plastic material in line with injection channels 30 provided in body 2. In order to avoid any distribution problem of injected plastic material, channels 30 are arranged in relation to a peripheral distribution groove 31. After placing injection head 28 in position, the plastic material is sent into channels 30 and fills the cavity defined by groove 4, detachable member 10 and impression 27 of mould 25, to form lining 3. So as to allow simultaneous injection of outer lining 8, body 2 also has a series of channels or passageways 32 ensuring communication between inner groove 4 and outer groove 20. The plastic material used may be of any nature appropriate for the function of linings 3 and 8 and preferably but not exclusively in elastomer such as natural latex or synthetic rubber.

After injection of the plastic material, the injection head 28 is removed and body 2 is released from mould 25. During this operation advantage is used of the plasticity of lining 8 which deforms to allow removal of body 2.

At this stage of manufacture, body 2 as shown in FIG. 6 comprises two linings 3 and 8 and detachable member 10. The latter is then detached from body 2 by exerting pressure along the direction of arrow P on the center of detachable member 10, so as to break the zone of lesser resistance 15. Also, under the effect of this pressure P the rupture of zones 16 divides detachable member 10 into several parts which can be easily removed from body 2. When breaking zone 15 the deformation capacity of inner lining 3 and more particularly of its lip 6 is used to assist removal of member 10.

This operation to remove detachable member 10 therefore makes it possible to obtain the final part ready for use according to the invention such as illustrated in FIG. 1.

It appears that with this method of manufacture and design of part 2 it is possible to produce an inner lining 3 by means of a mould of very simple design which does not have recourse to a core or slide. Therefore, with the proposed method it is possible to over-mould a lining 3 of particularly elaborate shape inside an inner bore of a mechanical part of small size whereas this was not possible in the prior art without having recourse to a mould of particularly complex and costly design which in most cases could not be contemplated for small-size parts.

Also, it is to be noted that according to the illustrated example, detachable member 10, through its impression, ensures the conformation of at least part of the functional surface of lining 3 and, in this case, of lip 6 forming a dynamic seal.

Also, detachable member 10 is preferably made such that it has no roughness or lines on its surface forming impression 11 of lip 6. Therefore lip 10 can be moulded with no irregularity, furrow or radial joint line as would have been the case with the technique of the prior art.

Also, the use of injection channels 32 on body 2 provides positive rotational immobilization of linings 3 and 8 on said body 2 through the presence of moulding cores which subsist in channels 30 after injection of plastic material. Therefore, in particularly advantageous manner, efficient anchoring is achieved of linings 3 and 8 which enhances static sealing between said linings and body 2. In the same way, the over-moulding of linings 3 and 8 ensures their good adhesion to body 2 without the addition of any adhesive product. Finally, it is also to be noted that the over-moulding of linings 3 and 8 onto body 2 avoids numerous handling operations of the latter and reduces risks of pollution with foreign particles to a maximum.

Also, being over-moulded, linings 3 and 8 are positioned inside their respective grooves in a state of relaxation with no residual stress such as could have resulted from force mounting or deformation.

The technique put forward by the invention may also be used to produce an outer lining arranged around body 2 of mechanical part 1. Hence FIG. 7 shows an example of a part 1 intended to form a command piston for example in the master cylinder of a clutch circuit. Piston 1 has a lining 40 providing a dynamic seal arranged in an outer bore 41.

According to the technique proposed by the invention, the outer lining is over-moulded on the piston. For this purpose, body 2 intended to house lining 40 has a detachable member 42 as illustrated in FIG. 8 arranged in relation to peripheral groove 41. This detachable member is joined to the body by a zone of lesser resistance 43₁ , and divided into two sectors by two scored rupture zones 43₂ that are substantially radial as shown in FIG. 9 in which member 42 is shaded.

Evidently, detachable member 42 has a surface 44 which defines, in part, the impression for over-moulding lining 30. Surface 44 is preferably conformed so as to be continuous so that it has no roughness or furrow likely to create defects in the seal lining for which it provides the mould.

For the injection of outer lining 30, body 2 is arranged as a central core in a mould 45 having an impression 46 complementary to impression 44 defined by detachable member 42 such as illustrated in FIG. 10.

Subsequently, the plastic material is injected in channels 47 arranged in body 2 of the part to fill the moulding cavity defined by groove 41, mould 45 and impression 44 presented by detachable member 42.

After injection of the plastic material and removal of the part from the mould, the part is in an intermediate condition in which body 2 carries both detachable member 42 and lining 40 as shown in FIG. 11. To separate detachable member 42 from body 2, pressure is exerted on detachable member 42 so as to separate it from body 2 by breaking the scored zone of lesser resistance and zones 43₂ dividing it into two separate zones. Removal of detachable member 42 then makes the mechanical part such as illustrated in FIG. 6 ready for insertion into the system for which it is intended.

Evidently, according to the invention, body 2 intended to receive via over-moulding one or more linings in plastic material, preferably in elastomer, could comprise several detachable members such as for example, but not exclusively, a detachable member arranged in relation to an outer groove to define an over-mould impression for an outer lining and a detachable member arranged inside said body to define, in relation to an inner groove, an over-mould impression for an inner lining.

In the same way, the use could be considered of several detachable members to conform one same lining.

Similarly, the method of manufacture has been described for a mono-impression mould to take a single-piece part. Evidently, according to the invention, over-moulding could be made by means of a multi-impression mould to take several bodies.

According to the examples illustrated and described above, the detachable member forms a single-piece assembly with body 2. However, according to the invention, the detachable member could be added to body 2 of the part before placing the body in the mould. The detachable member would then be fixed in any appropriate manner to the body so that it can be detached, at least in part. The detachable member could be screwed or clipped onto the body or even be made in several parts cooperating with one another to adapt around body 2.

Insofar as the lining is over-moulded in a groove, the detachable member could then preferably be adapted in relation to this groove.

Hence according to the example of embodiment of a master cylinder bearing illustrated in FIGS. 12 to 16, body 2 consists of the assembly of two elements, namely a base 2₁ of annular shape on which an annular crown 2₂ is adapted. Base 2₁can be made in any appropriate material such as a plastic material or metal, while crown 2₂ is preferably in plastic material and is over-moulded on base 2₂ so that it is joined to the latter by four links 50 of which only three are shown in the figures.

Links 50 make it possible to define an annular chamber 51 open towards the inside and outside for over-moulding lining 3.

According to this example, detachable member 10 is formed of a ring in plastic material 10 which is force fitted into a central bore of base 2₁ before over-moulding or placing in position crown 2₂.

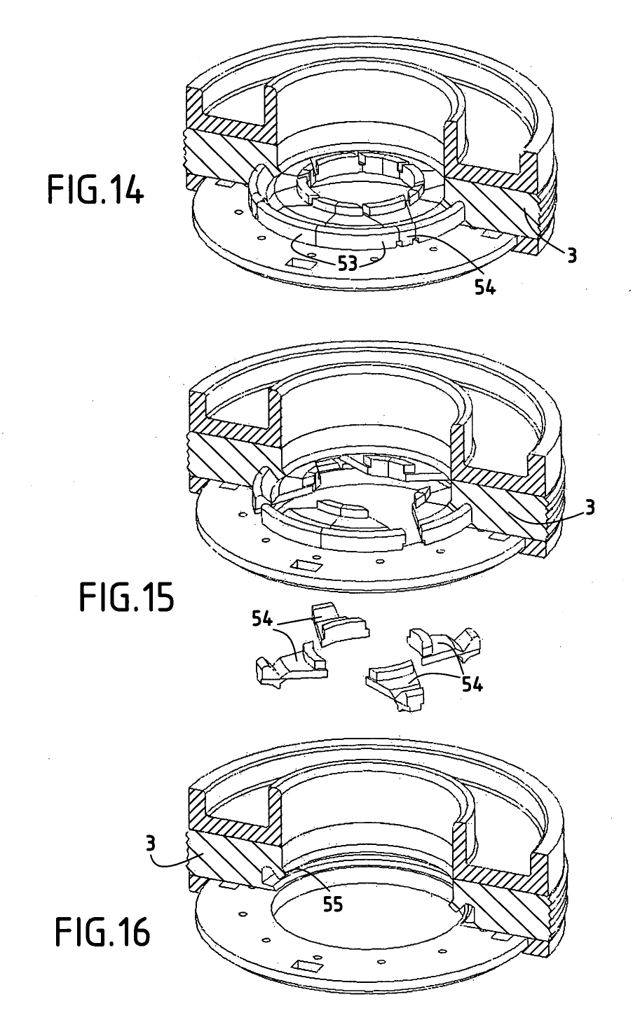

The over-moulding of lining 3, according to the method of the invention, is made as described previously so as to obtain the part such as illustrated in FIG. 14.

At this stage of manufacture, detachable member 10 is removed.

For this purpose, part 10 has a series of lines of lesser resistance 16 which define angular sectors 53, 54, of which four 54 placed at 90° to each other are delimited by lines converging towards the outside, so that after their removal as illustrated in FIG. 15 the other sectors 53 can be removed.

Therefore a part is obtained which has an over-moulded lining, more particularly illustrated in FIG. 16, detachable member 10 having allowed the moulding of an inner lip 55 providing a dynamic seal.

Similarly FIGS. 17 to 19 illustrate a particular embodiment of the body of a master cylinder piston, such as described in relation to FIGS. 7 to 11. According to this embodiment, body 2 is formed of two parts 2₁ and 2₂ as shown in the exploded view in FIG. 17.

Detachable member 42 is then force fitted onto one of parts 2₁ forming body 2 before the two parts are assembled together. Therefore body 2 is obtained fitted with the detachable member, as shown in FIGS. 18 and 19. It is to be noted that detachable member 42 has two lines of lesser resistance 43₂ enabling its removal as described previously.

Also the invention has been described for the manufacture of linings which ensure a guiding and/or sealing function within a mechanical system. Evidently, the invention can be used to produce mechanical parts which may or may not comprise one or more linings having other functions.

The invention is not restricted to the described, illustrated examples since various changes can be made thereto while remaining within the scope of the invention.

1. Mechanical part comprising a body (2) intended to receive at least one seal lining (3, 40) in plastic material, characterized in that the body (2) comprises at least one detachable member (10, 42) defining, at least in part, an impression (11, 44) for over-moulding lining (3,40) in plastic material.

2. Mechanical part according to claim 1, characterized in that impression (11,44) is intended to mould a functional sealing surface for lining (3, 40).

3. Mechanical part according to claim 2, characterized in that the impression (11, 44) is intended to mould a dynamic sealing surface for lining (3, 40).

4. Mechanical part according to claim 1 characterized in that the detachable member (10, 42) is joined to body (2 by at least one scored zone of lesser resistance (15, 43).

5. Mechanical part according to claim 1, characterized in that the detachable member (10, 42) is added to body (2).

6. Mechanical part according to claim 1, characterized in that the body (2) has a cavity (4) intended for the over-moulding of lining (3) inside the body and in that the detachable member (10) is arranged in relation to this cavity.

7. Mechanical part according to claim 6, characterized in that the detachable member (10) is arranged, at least in part, inside cavity (4).

8. Mechanical part according to claim 1, characterized in that the body (2) has a peripheral groove (41) intended for the over-moulding of lining (40) around body (2) and in that the detachable member (42) is arranged or adapted in relation to this groove (41).

9. Mechanical part according to claim 1, characterized in that the detachable member (10, 42) comprises at least two parts joined to one another via a zone (16, 43₂) of lesser resistance.

10. Mechanical part according to claim 1, characterized in that the body (2) has at least one channel (30, 47) for the injection of plastic material forming the lining (3, 40).

11. Mechanical part according to claim 1, characterized in that made in plastic material.

12. Mechanical part according to claim 1, characterized in that the body (2) and detachable member (10, 42) form a single-piece assembly.

13. Method for manufacturing a mechanical part comprising a body (2) fitted with at least one seal lining (3, 40) in plastic material characterized in that it comprises the following steps:
making the body (2) of the part so that it comprises at least one detachable member (10, 42) defining, at least in part, an impression (11, 44) for over-moulding lining (3),
placing body (2) as central core in a mould (25, 45),
closing the mould,
injecting plastic material to mould lining (3, 40) onto the body,
opening the mould,
releasing from the mould the mechanical part comprising the body (2) and its lining (3, 40),
detaching the detachable member (10, 42) from the body.

14. Manufacturing method according to claim 13, characterized in that it consists of ensuring the moulding of a functional sealing surface of lining (3, 40) by means of impression (11, 44) defined by the detachable member.

15. Manufacturing method according to claim 14, characterized in that it consists of ensuring the moulding of a dynamic sealing surface of lining (3, 40) by means of impression (11, 44).

16. Manufacturing method according to claim 13, characterized in that it consists of making body (2) and detachable member (10, 32) such that the detachable member is joined to body (2) by at least one zone of lesser resistance (15, 43₁) and of detaching the detachable member (10, 42) by breaking this zone of lesser resistance.

17. Manufacturing method according to claim 13, characterized in that it consists of adding the detachable member (10, 42) to body (2) before said body (20) is placed in mould (25, 45).

18. Manufacturing method according to claim 13, characterized in that it consists of:
making a cavity (4), in body (2) of the part, to over-mould lining (3),
arranging or adapting the detachable member (10) in relation to this cavity,
over-moulding lining (3) inside this cavity.

19. Manufacturing method according to claim 13, characterized in that it consists of:
making a groove (41) on the periphery of body(2) to over-mould lining (3),
arranging or adapting detachable member (42) in relation to this groove,
and over-moulding the lining around body (2).

20. Manufacturing method according to claim 13, characterized in that it consists of making at least one injection channel (30, 47) in the body of the part.

21. Manufacturing method according to claim 13, characterized in that it consists of dividing the detachable member (10, 42) into at least two parts joined by at least one zone of lesser resistance (16, 43₂).

22. Manufacturing method according to claim 13, characterized in that it consists of making body (2° of the part in injected plastic material.

23. Manufacturing method according to claim 13, characterized in that it consists of making lining (3, 40) in elastomer.

24. Mechanical part obtained with the manufacturing method according to claim 13.

25. Mechanical part according to claim 24, characterized in that it comprises at least one over-moulded lining (3, 40) in elastomer.
